(19) United States
(12) Patent Application Publication
(10) Pub. No.: US 2026/0219486 A1
(43) Pub. Date: Jul. 30, 2026

(54) LIGHT MICROSCOPE AND METHOD FOR LOCALIZING EMITTERS IN A SAMPLE

(71) Applicant: ABBERIOR INSTRUMENTS GMBH, Gottingen (DE)

(72) Inventors: Joachim FISCHER, Karlsruhe (DE); Tobias ENGELHARDT, Karlsruhe (DE); Gerald DONNERT, Gottingen (DE); Matthias REUSS, Gottingen (DE)

(21) Appl. No.: 19/456,034

(22) Filed: Jan. 22, 2026

(30) Foreign Application Priority Data
Jan. 30, 2025 (DE) 10 2025 103 516.4

(51) Int. Cl. G02B 21/00; G01N 21/64; G01N 21/65

(52) U.S. Cl. CPC G02B 21/0048; G02B 21/0032; G01N 21/6428; G01N 2021/6439; G01N 21/65

(57) ABSTRACT

A light microscope for localizing emitters in a sample, comprising a light source for generating an illumination light beam, a light modulator for spatially modulating a phase distribution and/or amplitude distribution of the illumination light beam, an objective for focusing the illumination light beam into a sample so that an intensity distribution with a local minimum is formed, a tube lens for imaging the illumination light beam into a rear aperture of the objective, a detector for detecting light emissions from the sample, a first scanning device arranged between the light source and the objective, a control unit for shifting the local minimum around a presumed position of an individual emitter, a computing unit for estimating a position of the emitter, and beam expansion optics arranged between the first scanning device and the tube lens, and a corresponding localization method.

### CROSS-REFERENCE TO RELATED APPLICATION

The present application claims the benefit of and priority to DE Patent Application Serial No. 10 2025 103 516.4 filed Jan. 30, 2025, the entire contents of which is incorporated herein by reference.

### TECHNICAL FIELD

The present disclosure relates to a light microscope for localizing emitters in a sample, in particular a MINFLUX microscope, and a method for localizing emitters in a sample, in particular a MINFLUX method.

### PRIOR ART

MINFLUX methods are localization microscopy methods in which the positions of individual emitters, e.g., fluorophores, in a sample are determined separately from one another. From the determined positions, a high-resolution image of the sample with resolutions in the single-digit nanometer range can be calculated. Alternatively, the method can be used to determine the positions of a single emitter moving in the sample with high temporal resolution in the microsecond range to determine the trajectory of the emitter in the sample (MINFLUX tracking).

Various implementations of the MINFLUX concept can be found in publications such as F. Balzarotti et al. (2017) Nanometer resolution imaging and tracking of fluorescent molecules with minimal photon fluxes, Science 355(6325 ), 606-612, K. C. Gwosch et al. (2020) MINFLUX nanoscopy delivers 3D multicolor nanometer resolution in cells, Nat. Methods, 17(2 ), 217-224, and R. Schmidt et al. (2021) MINFLUX nanometer-scale 3D imaging and microsecond-range tracking on a common fluorescence microscope, Nat. Commun. 12 (1), 1478.

In MINFLUX methods, the sample is illuminated with an intensity distribution of illumination light, in particular excitation light, which comprises a local minimum, in particular a zero point, and intensity increase areas adjacent to the minimum. This may be, for example, a donut or a bottle beam, light distributions that are known from STED microscopy, for example.

The minimum of the intensity distribution is arranged at illumination positions around a position of an individual emitter, which is determined in advance using an independent method, and light emissions from the sample are detected. The position of the emitter is then estimated with high accuracy using a position estimator based on the light emissions and the associated illumination positions. This process may be performed iteratively, i.e., after a position estimate, the sample is illuminated at least once again with the intensity distribution of the illumination light, wherein the illumination positions are placed around the emitter position determined in the previous step.

When excitation light is used as illumination light in a MINFLUX method, the fact that the closer the emitter is to the minimum of the intensity distribution, the less light it emits is exploited. This makes the method particularly photon efficient.

Various other variants of the MINFLUX technique are also described in particular in U.S. Pat. Nos. 9,719,928 B2, 10,900,901 B2, 10,908,089 B2, and 10,962,479 B2.

The U.S. Pat No. 11,255,791 B2 describes, among other things, a localization microscopy method that is a variant of the MINFLUX technique. In this method, the sample is illuminated with a combination of an excitation light distribution with a local maximum and a STED (stimulated emission depletion) light distribution with a local minimum. The position of a single emitter is also calculated from the light emissions recorded for different illumination positions, but the closer the minimum of the STED light distribution (and the maximum of the excitation light distribution superimposed on the minimum) is to the actual emitter position, the more light is emitted. This technique may also be referred to as STED-MINFLUX.

Many MINFLUX methods use electro-optical deflectors (EODs) to shift the intensity distribution to the illumination positions. These are well suited for this application because they are highly accurate and have a very fast response time, but a relatively small field of view. For rough pre-positioning in a larger image field, as well as for certain pre-localization methods and to be able to partially de-scan the detection light from the sample, additional mechanical beam scanners and/or stage scanners are usually used, e.g., galvanometer scanners or piezo scanners. A tandem scanner architecture is often used, in which the EODs are arranged between the light source of the microscope and a beam splitter, with the beam splitter separating the illumination light from the detection light emitted from the sample, while the mechanical beam scanner is arranged between the beam splitter and the objective, so that the illumination light passes through both scanners, but only the mechanical beam scanner de-scans the detection light.

Patent applications WO 2023/0166065 A1 and WO 2024/194179 A1 describe, among other things, MINFLUX methods that are performed exclusively with mechanical beam scanners, in particular galvanometer scanners.

Regardless of whether the illumination light in the sample is shifted exclusively with mechanical beam scanners during a localization method or whether the illumination light is scanned with electro-optical or other non-mechanical scanning devices, such as acousto-optical deflectors, wherein the illumination light additionally passes over a mechanical beam scanner, in particular a stationary one, the problem arises that position noise from the mechanical beam scanner may lead to errors in position determination. If position noise (also known as jitter) is present, the nominal position of the scanner read out by the control system of the scanning device deviates from the actual position. The registered illumination position of the minimum of the intensity distribution therefore does not correspond to the actual position, so that light emissions from the sample are assigned to the wrong position. The errors that occur here are in the order of magnitude of the position resolution of a MINFLUX method (especially in the single-digit nanometer range) and are therefore highly relevant for such high-resolution localization methods, in contrast to lower-resolution conventional scanning microscopy.

### OBJECTIVE

Therefore, the objective of the present disclosure is to reduce localization errors caused by position noise in a localization method.

### SOLUTION

This objective is attained by the subject matter of the independent claims (light microscope and method). Advantageous embodiments are specified in the dependent claims and are described below.

### DESCRIPTION

A first aspect relates to a light microscope for localizing emitters in a sample, comprising a light source (in particular a laser) configured to generate an illumination light beam, a light modulator (in particular a spatial light modulator, SLM, with controllable pixels or a phase filter) configured to modulate a spatial phase distribution and/or amplitude distribution of the illumination light beam, an objective configured to focus the modulated illumination light beam into a sample, so that an intensity distribution of the illumination light with a local minimum is formed in the sample around a focus of the illumination light beam, a tube lens configured to image the modulated illumination light beam into a rear aperture of the objective, a detector (in particular an avalanche photodiode, a photomultiplier, a hybrid detector, an array of the aforementioned detector types, or, also a camera) configured to detect the light emissions (in particular single photons) emanating from the emitters in the sample, a first scanning device arranged between the light source and the objective, the first scanning device being configured to shift the focus of the illumination light beam in the sample, a control unit, which is configured to shift the local minimum of the intensity distribution to illumination positions around a presumed position of an individual emitter in the sample, and a computing unit configured to evaluate light emissions from the individual emitter respectively detected by the detector at the illumination positions and to estimate a position of the individual emitter based on the evaluation (e.g., using a maximum likelihood estimator or a least squares estimator), wherein the light microscope comprises a beam expansion optic arranged between the first scanning device and the tube lens.

The beam expansion optics are configured to increase the beam diameter of the illumination light beam after it has passed through the first scanning device, particularly effectively in conjunction with other optics of the light microscope. Thereby, the effect of position noise of the first scanning device on the random fluctuation of the actual position of the illumination light focus in the sample is reduced by the magnification factor. This results in a lower position error when estimating the position of individual emitters.

This effect is independent of whether the illumination light beam is actually scanned with the first scanning device or whether it is deflected by a further second scanning device and merely passes through the first beam scanner to the objective.

The beam expansion optics may comprise a wide variety of optical elements known to those skilled in the art, e.g., lenses or prisms.

In particular, the beam expansion optics are configured to expand the illumination light beam by a factor of at least 1.5, particularly by a factor of at least 2, more particularly by a factor of at least 2.5, and even more particularly by a factor of at least 3.

The light microscope may particularly be a localization microscope, more particularly a MINFLUX microscope.

In the context of the present specification, “localization,” “localization method,” or “localization microscopy” refers to a method in which the emission light of single, in particular individual, emitters in the sample is detected and evaluated separately from neighboring emitters in the sample to determine the positions of the emitters individually. The emission light of several emitters may be detected in parallel or sequentially, as long as it can be assigned to the individual emitters and the emitter positions (localizations) can be determined individually. From the determined positions of the several emitters, a localization map may then be created, e.g., which resembles a high-resolution image of the sample. Alternatively, an emitter moving within the sample can be localized multiple times in succession using the localization method, e.g., to determine the emitter's trajectory.

In the context of this specification, the term “emitter” refers to objects which, when illuminated with excitation light, can be regarded as point light sources for the purposes of the measurements according to the method described herein. The light emitted by the object acting as a point light source may be, for example, scattered light resulting from elastic scattering such as Rayleigh scattering or inelastic scattering such as Raman scattering, or it may be luminescent light, in particular fluorescent light. An emitter may therefore be, for example, a light-reflecting nanoparticle, a quantum dot, a fluorescent dye molecule (fluorophore), or a molecule or nanoparticle labeled with one or more fluorescent dye molecules. Depending on the size of the molecule and the distance between the fluorophores, a molecule labeled with several fluorophores or a nanoparticle labeled with several fluorophores may be regarded as an emitter (point light source) or may also comprise several emitters in the sense of the definition used here.

The illumination light may be excitation light that excites the emitters, e.g., to fluoresce, or light that is scattered or reflected by the emitters. Alternatively, the illumination light may also be inhibition light, e.g., STED light, which prevents emitters excited by additional excitation light from emitting light.

In the context of this specification, “individual” emitters are understood to be emitters that can be optically separated from each other using light microscopy methods. This may be achieved by a labeling density of the sample that results in an average distance between the emitters above the diffraction limit. Alternatively, asynchronously blinking emitters may also be used if the sample conditions (in particular the composition of the sample buffer and embedding medium) are adjusted so that the average distances between the light-emitting emitters are highly likely to be above the diffraction limit at any given time. Finally, otherwise optically distinguishable different emitters may also be separated under certain circumstances if they have a distance below the diffraction limit, e.g., based on their characteristic emission spectrum or emission lifetime. Optionally, a spatially limited area of the sample may be illuminated with activation light to transfer emitters in this area from a dark state, in which the emitters do not emit light when irradiated with excitation light, to an active state, in which the emitters emit light when irradiated with excitation light.

According to an embodiment, the first scanning device is a mechanical beam scanning device, particularly a galvanometer scanning device. A beam scanning device is defined here as a device that shifts the illumination light beam relative to the objective of the microscope in at least one spatial direction. A mechanical beam scanning device is a beam scanning device that comprises at least one movable optical element, wherein the illumination light beam is deflected due to the movement of the optical element. A mechanical beam scanning device may comprise one movable optical element or several movable optical elements per spatial direction of displacement. A movable optical element may deflect the illumination light beam in one spatial direction (as is the case, for example, with galvanometer scanners) or in several spatial directions (as is the case, for example, with some MEMS scanners). The corresponding spatial directions of the deflection in the sample are particularly perpendicular to the optical axis of the objective, i.e., lateral directions, and may be designated, for example, as the x-direction and y-direction. In a galvanometer scanning device, the movable optical elements are mirrors that can be rotated around an axis, each of which can be rotated by a galvanometer drive. The illumination light beam typically passes over several mirrors in succession.

Mechanical beam scanners, in particular galvanometer scanners, are particularly robust and cost-effective, but have the disadvantage that their position noise is particularly pronounced.

According to a further embodiment, the control unit is configured to control the first scanning device in such a way that the local minimum of the intensity distribution is shifted to the illumination positions. This means that the first scanning device is used in the localization process to scan the illumination light focus across the sample.

According to a further embodiment, the light microscope comprises a second scanning device, in particular an electro-optical or acousto-optical scanning device, arranged between the light source and the first scanning device, wherein the control unit is configured to control the second scanning device in such a way that the local minimum of the intensity distribution is shifted to the illumination positions. The first scanning device is arranged in the beam path of the illumination light between the second scanning device and the objective, i.e., the illumination light beam passes over both scanning devices. Therein, the first scanning device may be “stationary,” i.e., it does not actively shift the illumination light beam relative to the sample. In the case of a mechanical scanning device, the optical elements that deflect the illumination light beam, e.g., mirrors, may be nominally at rest, but still impose positional noise on the illumination light beam, since the illumination light beam passes through the second beam scanning device and the first beam scanning device to the objective. Optionally, a beam splitter may be arranged between the second scanning device and the first scanning device, which separates light emissions emanating from the sample from the illumination light, e.g., reflects them into a detection beam path in which the detector is arranged. In this case, the first scanning device, but not the second scanning device, de-scans the detection light.

According to a further embodiment, the beam expansion optics comprise a telescope, wherein the telescope comprises a first telescope lens and a second telescope lens, and wherein the second telescope lens has a distance from the tube lens corresponding to twice the focal length of the second telescope lens. The first telescope lens and the second telescope lens have a distance from each other (i.e., a path length of the illumination light in the beam path between the first telescope lens and the second telescope lens) corresponding to the sum of the focal lengths of the first telescope lens and the second telescope lens. In particular, the focal lengths of the first telescope lens and the second telescope lens may be identical. In this case, their distance corresponds to twice the focal length. Depending on the focal lengths of the telescope lenses and the geometry of the structure, the telescope causes an expansion of the beam diameter of the illumination light beam.

According to a further embodiment, the light microscope comprises a first scanning lens arranged between the light source and the first scanning device, wherein the first scanning lens is configured to focus the illumination light beam into a first image plane within the first scanning device. The image plane may be arranged in particular on an optical element that causes beam deflection, or in the light path between several optical elements of the first scanning device, each of which causes beam deflection.

According to a further embodiment, the first telescope lens is configured to collimate the diverging illumination light beam emanating from the first scanning device. Due to the focusing of the illumination light beam by the first scanning lens into the first image plane within the first scanning device, the illumination light beam emanating from the first scanning device diverges. In this case, the function of the first telescope lens may consist in particular in collimating the diverging illumination light beam at a suitable beam width (at which the first telescope lens is positioned in the beam path). The second telescope lens focuses the collimated illumination light beam into a further image plane between the second telescope lens and the tube lens. The second telescope lens is arranged at a distance of twice its focal length from the tube lens, so that the tube lens focuses the illumination light beam into a collimated light beam of the desired beam diameter, which then enters the rear aperture of the objective and is focused by the objective onto the sample.

According to a further embodiment, the light microscope comprises a second scanning lens arranged between the first scanning device and the tube lens, wherein the second scanning lens is configured to focus the illumination light beam emanating from the first scanning device into a second image plane between the second scanning lens and the tube lens, wherein the beam expansion optics are arranged between the second scanning lens and the tube lens.

In such scanning devices (sometimes referred to as pupil scanners), the illumination light beam within the first scanning device may be collimated or approximately collimated. This means that a plane is arranged within the first scanning device that is conjugate to the rear aperture of the objective, i.e., it is a Fourier plane with respect to the focal plane in the sample and corresponding image planes in the microscope optics.

According to a further embodiment, the first telescope lens is configured to collimate the converging or diverging illumination light beam emanating from the second scanning lens. This means that the first telescope lens may be arranged in front of or behind the second image plane of the second scanning lens in the direction of travel of the illumination light beam. If the first telescope lens is arranged in front of the second image plane, there is no focus of the illumination light at the position of the second image plane, but the illumination light beam is collimated at this point due to the first telescope lens. The first telescope lens is positioned at a suitable point in the beam path so that the beam width of the converging or diverging illumination light beam corresponds to the desired expanded beam diameter. Here, too, the second telescope lens focuses the collimated illumination light beam into a further image plane between the second telescope lens and the tube lens. The second telescope lens is arranged at a distance of twice its focal length from the tube lens, so that the tube lens bundles the illumination light beam into a collimated light beam of the desired beam diameter, which then enters the rear aperture of the objective and is focused by the objective into the sample.

A second aspect of the present disclosure relates to a method for localizing emitters in a sample, in particular using the light microscope according to the first aspect, wherein an illumination light beam is generated, a spatial phase distribution and/or amplitude distribution of the illumination light beam is modulated, the modulated illumination light beam is imaged by a tube lens into a rear aperture of an objective, the modulated illumination light beam is focused into a sample by the objective, so that an intensity distribution of the illumination light with a local minimum is formed in the sample around a focus of the illumination light beam, light emissions originating from emitters in the sample are detected, the local minimum of the intensity distribution is shifted to illumination positions around a presumed position of an individual emitter in the sample, and light emissions from the individual emitter detected at the illumination positions are evaluated, and a position of the individual emitter is estimated based on the evaluation, wherein the illumination light beam is expanded between a first scanning device and the tube lens.

The localization method is, in particular, a MINFLUX method.

Further aspects and advantages of the method according to the second aspect are apparent from the description of the first aspect.

The following describes embodiments of the present disclosure with reference to figures. These do not limit the subject matter of this disclosure and the scope of protection.

### BRIEF DESCRIPTION OF THE FIGURES

FIG. 1 shows a first embodiment of a light microscope according to the present disclosure;

FIG. 2 shows a second embodiment of a light microscope according to the present disclosure.

### DESCRIPTION OF THE FIGURES

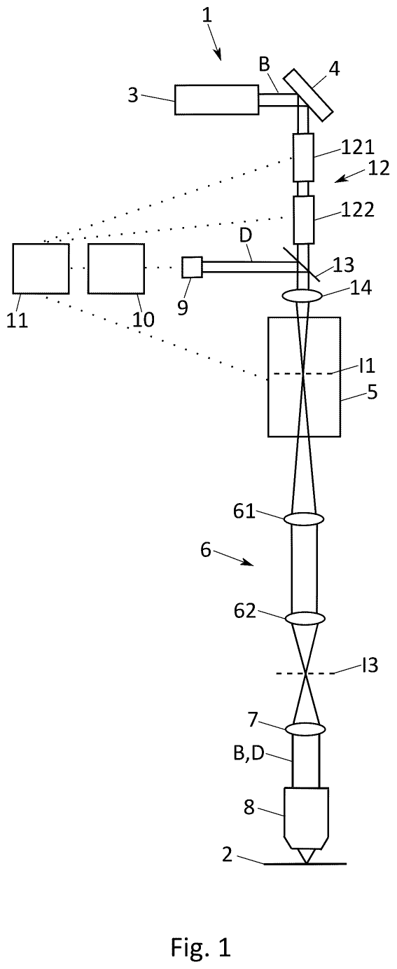

FIG. 1 schematically shows a light microscope 1 according to the present disclosure for localizing emitters in a sample 2, namely a MINFLUX microscope, according to a first embodiment.

The light microscope 1 comprises a light source 3, particularly a laser, which generates an illumination light beam B. The illumination light is particularly excitation light which excites emitters in the sample 2, e.g. to luminescence, in particular fluorescence. The illumination light beam B passes through a light modulator 4, e.g., a reflective or light-diffracting spatial light modulator with controllable pixels, wherein the light modulator 4 modulates the spatial phase and/or amplitude distribution of the illumination light beam B, e.g., with a vortex phase pattern or a ring-shaped phase pattern. By focusing the illumination light beam B using the objective 8, an intensity distribution of the illumination light with a local minimum, particularly a zero point, is formed at the focus.

The modulated illumination light beam B passes through an optional second scanning device 12, comprising a first deflector 121 and a second deflector 122, which are arranged one behind the other in the beam path of the illumination light beam B and can deflect the illumination light beam B in different spatial directions to scan the focus of the illumination light beam B in the sample 2. The deflectors 121, 122 may be, for example, electro-optical or acousto-optical deflectors.

A beam splitter 13, e.g., a dichroic beam splitter, is arranged in the beam path behind the second scanning device 12, which separates the illumination light from detection light D emitted from the sample 2 by transmitting the illumination light beam B and reflecting the detection light D.

The illumination light transmitted by the beam splitter 13 is focused by a first scanning lens 14 into a first image plane I1 within a first scanning device 5, e.g., a galvanometer scanning device. The first scanning device 5 can deflect the illumination light beam B, particularly in several spatial directions, to scan the focus of the illumination light beam B in the sample 2. In addition, the first scanning device 5 de-scans the detection light D. The first scanning device 5 may comprise one movable optical element, e.g., a rotating mirror, per spatial direction of deflection, or several such optical elements per spatial direction of deflection. In particular, the first image plane I1 is arranged in the beam path between the optical elements. For example, two optical elements (e.g., galvanometer mirrors) may be provided for each of two mutually perpendicular lateral spatial directions of displacement in the sample, both of which are perpendicular to an optical axis of the objective. Such a scanning device may be referred to as a quad scanner.

The illumination light beam B emanating from the first scanning device 5 passes through a beam expansion optic 6, which, according to the embodiment shown, is configured as a telescope comprising a first telescope lens 61 and a second telescope lens 62. The first telescope lens 61 collimates the illumination light beam B emanating from the first scanning device 5. The second telescope lens 62 focuses the expanded illumination light beam B into a third image plane I3 between the second telescope lens 62 and the tube lens 7. The third image plane I3 is at a distance from the tube lens 7 which corresponds to the focal length of the tube lens 7, so that the tube lens 7 collimates the illumination light beam B. The expanded illumination light beam B collimated by the tube lens 7 enters the rear aperture of the objective 8, which focuses the illumination light beam B into the sample 2. The expansion of the illumination light beam B reduces the effects of positional noise of the first scanning device 5 on the random fluctuation of the focus position in the sample 2. This results in higher positional accuracy for the localization method that can be performed with the light microscope 1.

Detection light emitted by emitters in the sample (e.g., luminescence, in particular fluorescence light) is focused by the objective 8, de-scanned by the first scanning device 5, reflected by the beam splitter 13, and detected by a detector 9.

The detector 9 is connected to a computing unit 10, which registers and evaluates light emissions detected by the detector 9 and additionally receives information about the nominal and/or actual positions of the first scanning device 5 and/or the second scanning device.

Furthermore, a control unit 11 is provided, which is connected at least to the computing unit 10 and/or the detector 9 and the first scanning device 5 and/or the second scanning device 12 and is configured to control the first scanning device 5 and/or the second scanning device 12 to arrange the focus of the illumination light, namely the local minimum of the intensity distribution of the illumination light, at illumination positions in the sample 2.

To implement a localization method such as a MINFLUX method, the local minimum of the intensity distribution of the illumination light may be arranged with the first scanning device 5 and/or the second scanning device 12 at an illumination pattern of illumination positions around a previously roughly estimated position of an individual emitter, and for each illumination position, the light emissions detected from the sample 2 may be recorded, e.g., during a dwell time. Alternatively, the local minimum of the intensity distribution may be moved in a continuous motion over or through the sample 2, and the detected light emissions may be assigned to specific illumination positions. In both cases, the computing unit 10 may estimate a position of the emitter based on the illumination positions and the assigned light emissions. This process may optionally be continued iteratively.

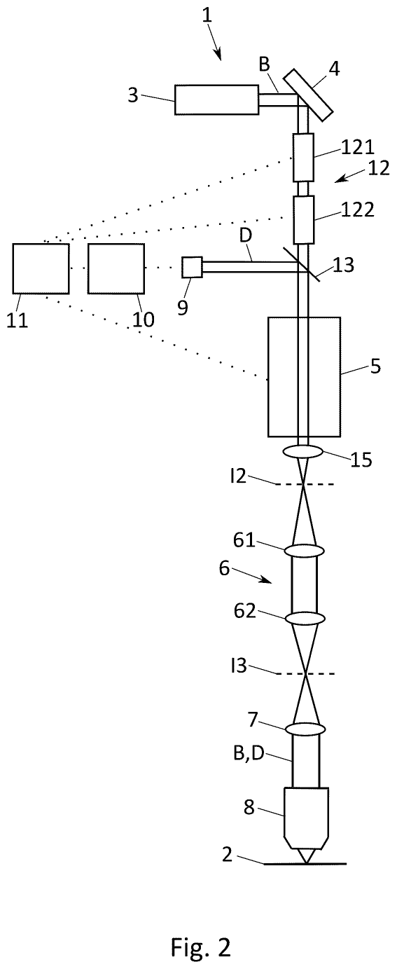

The light microscope 1 shown in FIG. 2 differs from the light microscope 1 shown in FIG. 1 only in the type of first scanning device 5 and the arrangement of the beam expansion optics 6. Identical or analogous components are labeled with the same reference numbers.

Here, instead of the first scanning lens 14 arranged between the beam splitter 13 and the first scanning device 5, a second scanning lens 15 is arranged between the scanning device 5 and the beam expansion optics 6.

The illumination beam B is guided in a substantially collimated manner through the optical elements of the first scanning device 5. Such scanning devices may also be referred to as pupil scanners, since a plane within the scanning device 5 is conjugate to the rear aperture (also known as the pupil) of the objective 8. This pupil plane may be arranged, for example, on one of several movable optical elements, e.g., galvanometer mirrors. For the remaining movable optical elements, the image in the rear aperture of the objective 8 is then only approximate. If necessary, additional optics, e.g., telescopes, may be provided in the beam path between the light source 3 and the first scanning device 5 (not shown).

The second scanning lens 15 focuses the illumination light beam B emanating from the first scanning device 5 into a second image plane I2 between the second scanning lens 15 and the first telescope lens 61 of the beam expansion optics 6. The first telescope lens 61 collimates the illumination light beam B and expands it. The second telescope lens 62 focuses the expanded illumination light beam into a third image plane I3 between the second telescope lens 62 and the tube lens 7. The third image plane I3 is spaced from the tube lens 7 by a distance corresponding to the focal length of the tube lens 7. The tube lens 7 generates a collimated illumination light beam B, which enters the rear aperture of the objective 8, so that the illumination light beam B is focused by the objective 8 into the sample 2.

### List of Reference Symbols

1 Light microscope
2 Sample
3 Light source
4 Light modulator
5 First scanning device
6 Beam expansion optics
7 Tube lens
8 Objective
9 Detector
10 Computing unit
11 Control unit
12 Second scanning device
13 Beam splitter
14 First scanning lens
15 Second scanning lens
61 First telescope lens
62 Second telescope lens
First deflector
Second deflector
B Illumination light beam
D Detection light
I1 First image plane
I2 Second image plane
I3 Third image plane

1. A light microscope for localizing emitters in a sample, comprising
a light source configured to generate an illumination light beam,
a light modulator configured to modulate a spatial phase distribution and/or amplitude distribution of the illumination light beam,
an objective configured to focus the modulated illumination light beam into a sample so that an intensity distribution of the illumination light with a local minimum is formed in the sample around a focus of the illumination light beam,
a tube lens configured to image the modulated illumination light beam into a rear aperture of the objective,
a detector configured to detect light emissions emanating from the emitters in the sample,
a first scanning device arranged between the light source and the objective, the first scanning device being configured to shift the focus of the illumination light beam in the sample,
a control unit configured to shift the local minimum of the intensity distribution to illumination positions around a presumed position of an individual emitter in the sample, and
a computing unit configured to evaluate the light emissions from the individual emitter respectively detected by the detector at the illumination positions and to estimate a position of the individual emitter based on the evaluation, wherein
the light microscope comprises a beam expansion optic arranged between the first scanning device and the tube lens.

2. The light microscope according to claim 1, wherein the first scanning device is a mechanical beam scanning device.

3. The light microscope according to claim 2, wherein the mechanical beam scanning device is a galvanometer scanning device.

4. The light microscope according to claim 1, wherein the control unit is configured to control the first scanning device in such a way that the local minimum of the intensity distribution is shifted to the illumination positions.

5. The light microscope according to claim 1, wherein the light microscope comprises a second scanning device arranged between the light source and the first scanning device, wherein the control unit is configured to control the second scanning device in such a way that the local minimum of the intensity distribution is shifted to the illumination positions.

6. The light microscope according to claim 5, wherein the first scanning device is an electro-optical or acousto-optical scanning device.

7. The light microscope according to claim 1, wherein the beam expansion optics comprises a telescope, wherein the telescope comprises a first telescope lens and a second telescope lens, wherein the second telescope lens has a distance from the tube lens which corresponds to twice the focal length of the second telescope lens.

8. The light microscope according to claim 7 wherein the light microscope comprises a first scanning lens arranged between the light source and the first scanning device, the first scanning lens being configured to focus the illumination light beam into a first image plane within the first scanning device.

9. The light microscope according to claim 8, wherein the first telescope lens is configured to collimate a diverging illumination light beam emanating from the first scanning device.

10. The light microscope according to claim 7, wherein the light microscope comprises a second scanning lens arranged between the first scanning device and the tube lens, the second scanning lens being configured to focus the illumination light beam emanating from the first scanning device into a second image plane between the second scanning lens and the tube lens, wherein the beam expansion optics are arranged between the second scanning lens and the tube lens.

11. The light microscope according to claim 10, wherein the first telescope lens is configured to collimate a converging or diverging illumination light beam emanating from the second scanning lens.

12. The light microscope according to claim 1, wherein the beam expansion optics are configured to expand the illumination light beam by a factor of at least 1.5.

13. The light microscope according to claim 1, wherein the beam expansion optics are configured to expand the illumination light beam by a factor of at least 2.

14. The light microscope according to claim 1, wherein the beam expansion optics are configured to expand the illumination light beam by a factor of at least 3.

15. The light microscope according to claim 1, wherein the light microscope is a localization microscope, wherein the detector is configured to detect emission light of individual emitters in the sample, and wherein the computing unit is configured to evaluate the emission light separately from neighboring emitters in the sample to determine positions of the emitters individually.

16. The light microscope according to claim 1, wherein the light microscope is a MINFLUX microscope, wherein the control unit is configured to arrange the intensity distribution of the illumination light at an illumination pattern of illumination positions around a previously roughly estimated position of an individual emitter, wherein the detector is configured to record the light emissions detected from the sample for each illumination position, and wherein the computing unit is configured to estimate a position of the emitter based on the illumination positions and the assigned light emissions.

17. A method for localizing emitters in a sample, wherein
an illumination light beam is generated,
a spatial phase distribution and/or amplitude distribution of the illumination light beam is modulated,
the modulated illumination light beam is imaged by a tube lens into a rear aperture of an objective,
the modulated illumination light beam is focused into a sample by the objective so that an intensity distribution of the illumination light with a local minimum is formed in the sample around a focus of the illumination light beam,
light emissions originating from emitters in the sample are detected,
the local minimum of the intensity distribution is shifted to illumination positions around a presumed position of an individual emitter in the sample, and
light emissions from the individual emitter detected at the illumination positions are evaluated and a position of the individual emitter is estimated based on the evaluation,
wherein the illumination light beam is expanded between a first scanning device and the tube lens.

18. The method according to claim 17, wherein emission light of individual emitters in the sample is detected, and wherein the emission light is evaluated separately from neighboring emitters in the sample to determine positions of the emitters individually.

19. The light microscope according to claim 17, wherein the method for localizing emitters in the sample is a MINFLUX method, wherein the intensity distribution of the illumination light is arranged at an illumination pattern of illumination positions around a previously roughly estimated position of an individual emitter, wherein the light emissions detected from the sample are recorded for each illumination position, and wherein a position of the emitter is estimated based on the illumination positions and the assigned light emissions.
